(19) United States
(12) Patent Application Publication
(10) Pub. No.: US 2013/0232147 A1
(43) Pub. Date: Sep. 5, 2013

(54) GENERATING A TAXONOMY FROM UNSTRUCTURED INFORMATION

(71) Applicants: Pankaj Mehra, San Jose, CA (US); Alexander Ulanov, Saint Petersburg (RU); Andrey Simanovsky, Saint Petersburg (RU)

(72) Inventors: Pankaj Mehra, San Jose, CA (US); Alexander Ulanov, Saint Petersburg (RU); Andrey Simanovsky, Saint Petersburg (RU)

(21) Appl. No.: 13/879,427

(22) PCT Filed: Oct. 29, 2010
(86) PCT No.: PCT/US10/54611

§ 371 Date: Apr. 15, 2013

(51) Int. Cl. G06F 17/30

(52) U.S. Cl. CPC G06F 17/30705
USPC 707/737

(57) ABSTRACT

At least one term is extracted [202] from unstructured information. The at least one term is validated [204]. Then, a sense of the at least one extracted and validated term is determined [206]. The at least one extracted and validated term is clustered [208] into at least one group of terms according to the determined sense. A taxonomy is generated [210] based on the clustering and a mining of accessible taxonomies.

### BACKGROUND

The world of information is exploding. Eighty to ninety-five percent of this information is unstructured shared documents, such as email, files, images, etc. Only about five to ten percent of this information has been converted into structured data that can be placed in databases. The World Wide Web (WWW) connects such information when it is out in the open. However, generally, businesses retain this type of information and do not share it on the WWW. Thus, many times businesses have a difficult time recalling the location of a specific unstructured shared document.

### DESCRIPTION OF THE DRAWINGS

FIG. 1 is a block diagram of system for generating taxonomies from unstructured information, according to one embodiment of the present technology.

FIG. 2A is a flow diagram of a method for generating taxonomies from unstructured information, according to one embodiment of the present technology.

FIG. 2B is a flow diagram of a method for generating taxonomies from unstructured information, according to one embodiment of the present technology.

FIG. 3 is a diagram of an example computer system used for generating taxonomies from unstructured information, according to one embodiment of the present technology.

FIG. 4 shows an algorithm that explains the idea of a distance function, according to embodiments of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “extracting”, “validating”, “determining”, “clustering”, “generating”, “disambiguating”, “assigning”, “estimating”, “grouping”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical computers.

The discussion will begin with a brief overview of methods of building taxonomies. The discussion will then focus on embodiments of the present technology that provide for a system and method for extracting core sense of various topics (ambiguous and unambiguous) in text documents.

### Overview

In general, in order to recall the placement of unstructured shared documents, one must remember where it was placed, or perform a key word search to determine its location. However, since vocabularies evolve and people do not always use the same word to describe the same thing, connections between documents may become lost.

While public search engines have about three million concepts, there are more than one hundred million concepts world wide. If one tries to understand the contents of a business's unstructured shared documents in terms of public taxonomies like the Library of Congress or a public encyclopedic search engine, it is found that only about three to five percent of total topics in any specialization area are actually easily mapped into the Library of Congress subject headings or a public search engine's topic headings.

There is difficulty in making sense of words and phrases that are present in the business documents, as well as organizing these words and phrases and keeping them aligned with how the general public thinks about the information.

Embodiments of the present technology utilize the semantic content of these unstructured shared documents to locate documents and publish them in a taxonomy format that is related to public taxonomies, such as but not limited to, public encyclopedic search engines. More particularly, embodiments extract and validate terms within a shared unstructured document, make sense of the extracted and validated terms, look at the possible senses of these terms, and then organize these terms according to shared senses by mining public taxonomies.

Currently, when a business looks to create a taxonomy for new areas or an existing area of competency, the business enters a search query to find related public search engine articles by consulting either a private or a public index of the public search engine articles. In other words, related information associated with the search query is desired. For example, if the term, “Van Gogh” is entered as a search query, articles for movements, such as impressionism, cubism, etc, of which the artist might be considered a part, is returned. In another example, the names of people and concepts that are concrete as well as abstract might be requested. These names may then be organized into “need” categories, according to needs of the person requesting the information. Thus, related terms to a search query are discovered and organized in a hierarchy of topics according to the user's world view and perspective, while respecting the user's focus or interests

To a large extent, this currently used type of taxonomy search tool can be automated and routinely performed by what is known as a clustering search engine. For example, a query is run on a clustering search engine, and a taxonomy is presented based on a lot of similar systems, such as a public search engine. The taxonomy is prepared by mining the public search engines' categories of hierarchy,

This can be shown in the following example. A user types in a query regarding using terms that relate to a particular tobacco lawsuit. In this example, the taxonomy tool returns the result showing that, among other topics, big oil and the tobacco institute are both related to tobacco. After receiving this search return of related topics, the user then manually selects “health care” as an overarching view that he/she would like to import on the set of terms that have been discovered by the taxonomy tool. The user is trying to figure out what is the taxonomy of topics related to tobacco and cigarettes from a health care perspective. The taxonomy tool responds by making sense out of the user's selection of “health care” as well as the discovered terms and identifies articles from a public search engine, such as Wikipedia, that relate to the user's topic.

The taxonomy tool then returns a search result in which concepts relating to the search query are placed in a hierarchical order, from broadest to narrowest topic. In the following example, “health” is the broadest topic and “tobacciana” is the narrowest topic: health, disability, mental illness, substance, addition, tobacco, and tobacciana. As further explanation of the relationship of these topics, the terms “tobacciana” and “tobacco” are considered to be related to health through the idea of “addiction”. The user then manually selects the topics of interest, “tobacco” and also manually excludes the topic, “tobacciana”. The user is able to do this many times in relation to related search queries. From the user's manual selection of concepts, the taxonomy tool is able to build a domain model.

Continuing to follow the tobacco example, the taxonomy tool presents to the user the following concepts that are related to “tobacco” under the “health care” view, “tobacco package warning signs”, “surgeon general's warning”, and “health warnings”. These concepts are synonymous with each other. These synonymous concepts are also assigned a value that represents the probability that the particular concept is one that the user had in mind when entering the original search query.

The taxonomy tool then takes all of the concepts according to their relevance, as indicated by the assigned probability values, and organizes the concepts into a hierarchy of topics. The category of “cigarettes” (having an assigned probability value) is listed under the category of “tobacco”. The categories, “cigarette additives”, “cigarette brand” (also having assigned probability values) and so on are listed under the category of “cigarettes”.

The limitations of the current method of building a taxonomy are based in the idea that the user must determine queries and select concepts that instruct a system to perform searches. However, consider the case in which a company already has a very good descriptive document in a collection of documents. The user does not want to have to repeatedly type queries and select concepts to determine related terms and topics. Embodiments of the present technology enable unstructured documents to be read, the meaning of concepts there within to be determined and related topics of interest to the user to be found; the user does not need to repeatedly type new search queries and indicate selections in order to build a useful taxonomy.

For example, take the situation in which an oil and gas major desired to build a highly focused vocabulary of topics regarding occupational hazard and safety at oil refineries. The interest was in trying to have a deeper understanding of the health and safety issues in oil refineries. In this case, the oil and gas major already had a very relevant and professional 40 page PDF document from a society of chemical engineers that explained various concepts having to do with chemical plant and process safety. So, instead of stopping the development of the taxonomy when it reaches the node, “process safety management”, embodiments of the present technology read the document and develop a further taxonomy under the node, “process safety management” that explains process safety management in depth. Embodiments indicate more than the fact that “process safety management” is a health and safety topic.

Thus, the current method requires a user to enter an abundance of queries and to make selections of concepts in order to aid in the development of a desired taxonomy. Embodiments of the present technology enable the extraction of core senses of various topics within text documents.

The following discussion will begin with a description of the structure of the components of the present technology. The discussion will then be followed by a description of the components in operation.

### Structure

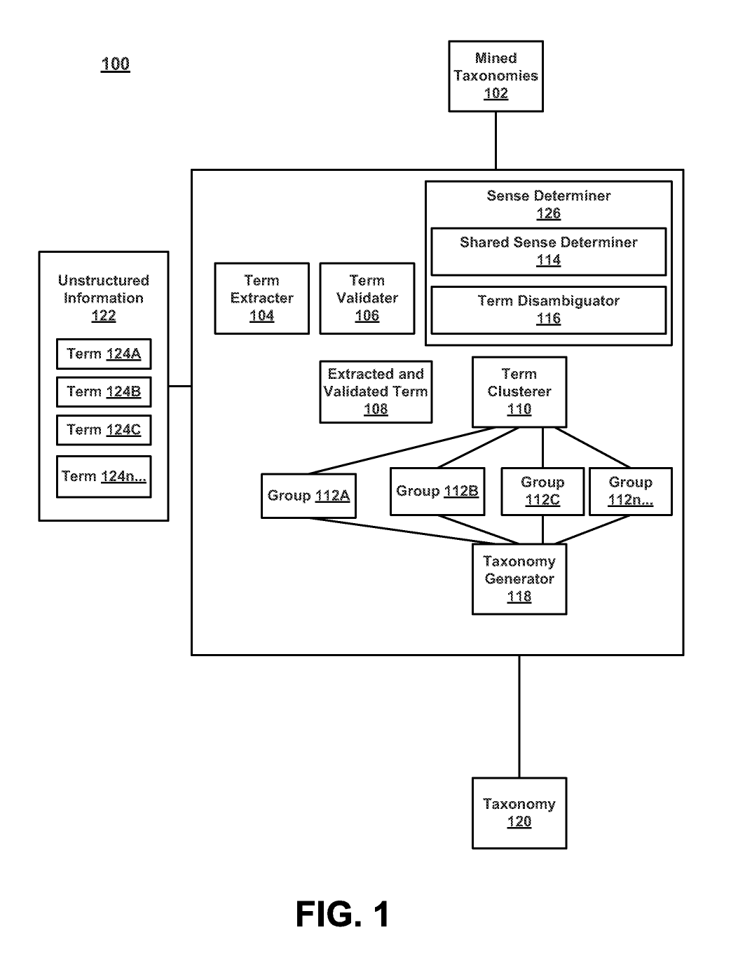

FIG. 1A is a block diagram of a system 100 for generating taxonomies from unstructured information 122, according to one embodiment of the present technology. In one embodiment, the system 100 includes a term extractor, a term validater 106, a sense determiner 126 a term clusterer 110 and a taxonomy generator 118. In other embodiments, the system 100 includes one or more of the following: a shared sense determiner 114; and a term disambiguater 116.

In one embodiment, the term extractor extracts at least one term 124A, 124B, 124C, and 124n . . . from unstructured information 122. In embodiments of the present technology, unstructured information 122 may be one of, but not limited to the following: a document, a web page, an email, etc. The at least one term 124A, 124B, 124C and 124n . . . , for purposes of brevity and clarity, will be referred to hereinafter as “at least one term 124”, unless otherwise noted, as term. In one embodiment, the document contains text. In one embodiment, the term validater 106 validates the at least one term 124. The term extracter 104 and the term validater 106 will be discussed herein together in the following explanation.

Embodiments of the present technology use linguistic patterns to analyze a corpus of documents in order to extract terms, using techniques well known in the art. These linguistic patterns may be embedded within an embodiment, or be accessible to an embodiment. An example of a linguistic pattern is a noun followed by a noun followed by another noun, such as “information life cycle management”. Another example is an adjective followed by a noun, such as “good day”. For example, and continuing with the example of the oil and gas company, if a document about chemical plant process safety is analyzed, then an embodiment might come up with the topic, “respiratory hazards”, as one concept to explore. However, it in not known, when determining that “respiratory hazards” is a concept to explore, if such a phrase is a real thing is real or just an odd chance combination of words that do not mean very much, taken out of context. Embodiments of the present technology value concepts such as, “respiratory hazards”, and determine if it is a valid concept. In other words, embodiments determine if the meaning of the term, “respiratory hazards” can be understood by a specialist in that field as indicated by this heuristic, that is a textbook heuristic.

In other words, a textbook technique is used to identify candidate terms for further study by reading documents and applying linguistic patterns. This is routinely done by librarians and taxonomers when they are preparing taxonomies in the library. Embodiments of the present technology go beyond identifying candidate terms. An embodiment uses a computer program to match a concept against one of the three million concepts available at Wikipedia and five and one half million synonyms available from other accessible programs. So, simply by extracting a set of terms from documents, and using Wikipedia as a validation corpus, we can identify about eight and one half million concepts in all. However, more validation is needed because the universe of concepts is much larger than eight and one half million. It is believed that the universe holds about 100,000,000 concepts.

Thus, it is not enough to just validate those things that are either directly created topics in Wikipedia, or words and phrases that are synonymous with those topics, as deemed by some software. Embodiments of the present technology apply additional validation techniques. Embodiments look at the rest of the document under study, and determine the likely sense of the extracted terms that are not ambiguous and that can be validated.

Thus, the following example will explain this concept. There are extracted terms that can be explained by a taxonomy and extracted terms that cannot be explained by the same taxonomy. It should be noted that a taxonomy may be not only Wikipedia, but may be any private or public search engine. A taxonomy may be the English dictionary, or any lexicon of terms, such as, but not limited to, the Library of Congress subject headings, etc. Take, for example, a head note (comprising a paragraph of wording) on a document to be analyzed. Embodiments detect various concepts that can be explained in terms of, say, Wikipedia, and terms that cannot be explained. For instance, it is found that the concept of “clause” maps to (related to) the Wikipedia document, contract“. The word, “venue” is related to the document, “change of venue”, “circumstance” is related to the document, “attendant circumstance”, and “enforcement” means, “coming into force” (which is the nearest Wikipedia topic). The terms, “clause”, “contract”, “venue”, “change of venue” and “enforcement” are categorized with high confidence as being either Wikipedia topics directly or are synonymous with certain Wikipedia topics.

However, there are also some nonvalidated terms that are not able to map into Wikipedia topics, like the terms, “day in court” and “inconvenience”. Thus, an embodiment reads a document, determines whether certain extracted terms are validated or nonvalidated, and organizes the extracted terms into a taxonomy. Embodiments of the present technology programs in a very large number of titles, thereby achieving a high recall first. Then, embodiments have a very aggressive validation method, which allows it to achieve high levels of precision.

In one embodiment, the sense determiner 126 determines a sense of at least one extracted and validated term 108. Embodiments consider individual words and the likelihood that these words should be put together in such as way as to make jargon. For example, an embodiment determines if one of the words or phrases has something to do with the domain in which the combined phrase is placed. An embodiment then determines a probability in relation to this likelihood. For example, individual words, such as “string” and “theory” are found to be adjacent to each other. However, Wikipedia does not have an article about “string theory”. Further, the word, “string”, has many meanings, and the word “theory”, has many meanings. So, embodiments of the present technology will determine if “string” is a term for quilting or if it is a term for physics. Embodiments of the present technology would then look at the individual words, “string” and “theory” and determine the likelihood that these words should be put together in this way to make jargon. Embodiments try to determine the probability (or likelihood) that string and theory have something to do with “physics”, and if it is a valid phrase in physics,

In one embodiment, the sense determiner 126 includes one or more of the following: a shared sense determiner 114; and a term disambiguater 116.

[00361 In one embodiment, the shared sense determiner 114 determines a shared sense of a first set of the at least one extracted and validated term 108 that is unambiguous. A first set may include one or more extracted and validated terms 108. For example, out of the tens of thousands of terms that can come out of a forty page document, not all terms are ambiguous, in the sense that embodiments do not have to work really hard to figure out what the terms mean. Some terms are common phrases that are well understood by lay persons or by those well versed in the state of the art. So there is no ambiguity about the meaning of certain terms. Such terms can frequently be found in Wikipedia. For those terms that are known to be well understood and unambiguous, embodiments determine the strongest shared sense of the terms that makes sense for the whole document. For example, consider the words, “string” and “force”, which are common words found in society. However, in considering the combination of these terms, “string force”, the strongest shared sense that these two terms have is physics, even though the term, “force” can be used in sports, politics or in other areas. However, the fact that string, force and acceleration are all present in the document, then the strongest shared sense that these terms have is physics, which indicates that the content of the document has to do with physics.

In one embodiment, the term clusterer 110 clusters the at least one extracted and validated term 108 into at least one group 112A, 112B, 1120 and 112n . . . of terms according to a determined sense. Of note, for purposes of brevity and clarity, the at least one group 112A, 112B, 112C and 112n . . . of terms is referred to hereinafter as “at least one group 112”, unless otherwise specifically noted.

Embodiments of the present technology take a given term and look for broader terms that may cover the given term and that makes sense. So, for example, the word vector can be used in aerospace, in which case it is the course of an aircraft. Further, the word vector can be used in the mathematical sense, in which case it presents a line with a direction. Embodiments determine which of these senses are relevant in a particular document that contains the word vector. Embodiments looks at these possible senses as though they were potential sense paths in the taxonomy hierarchy, and it determines which senses share a lot of meaning. So, the way that the word vector relates to physics is that it relates to axis and dimensions, which relates to measurements, which relates to mathematical modeling and measurements. In the document, there may be another term, “scalar”, which shares many of these meanings. Embodiments favor terms that share low level meanings. Thus, two terms relating to measurements as well as generally belonging in physics will be preferred and be considered to be closer to each other than two terms that only belong in physics and don't share a narrow sense of meaning. In fact, embodiments place more weight on narrower shared meanings than it does on broader shared meanings. Such intuition is captured in the present system 100′s distance functions. Thus, embodiments favor the narrower sharing of senses versus the broader sharing of senses.

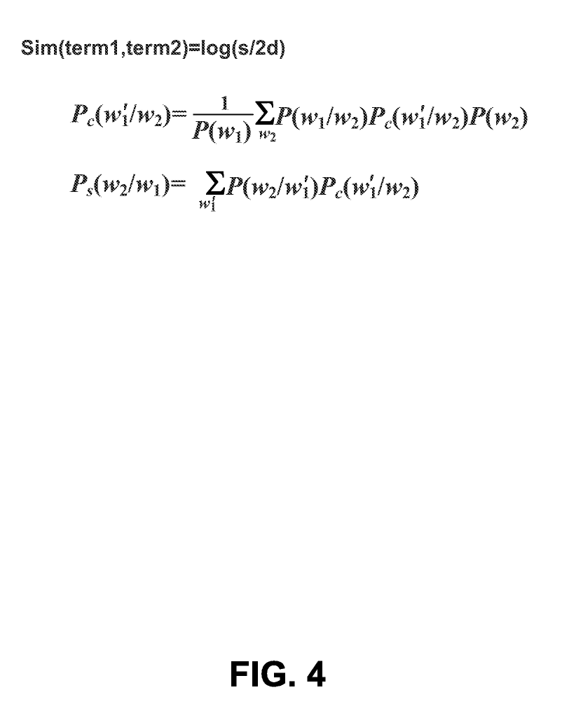

FIG. 4 shows an algorithm that explains the idea of a distance function, according to embodiments of the present technology.

In one embodiment, the term disambiguater 116, based on the determined shared sense(s) as explained herein, disambiguates a second set of the at least one extracted and validated terms 108 that is ambiguous. The second set may include one or more extracted and validated terms 108. Embodiments of the present technology takes those terms that are ambiguous and use the shared sense that has been extracted through the clustering of senses to disambiguate single word terms, such as “party”. As known, the word, “party”, can be present in the document in the sense of law, politics or fun. If it is present in the sense of law, it could mean defendant or plaintiff. If it is present in the sense of politics, it could mean Democrat or Republican. If it is present in the sense of fun, it might be a beach party in Santa Barbara.

Taking this into account, an embodiment looks at the rest of the words that have been clustered based on the determined senses (as described herein), and it is understood where the center of sense is in this document. Embodiments then use the clustered terms to reject certain senses of highly ambiguous words, like single words and common phrases. For example, embodiments might determine that the “cloud” in cloud computing” is really about the Internet and not about weather phenomena. Further, once it has been determined that a document is about a topic, such as physics, then if the word, such as “force”, has a political meaning, that meaning is not even considered.

Thus, embodiments of the present technology do not try to extract meanings of words in isolation, and do not look at very ambiguous words directly. Instead, embodiments look at the document and look at the unambiguous terms in the document, that in some cases, have eight or fewer senses, and try to cluster those senses to see which senses are shared by most of the unambiguous words in the document. This method of clustering enables embodiments to determine the core sense meaning in the document. This core sense meaning is used then to disambiguate the highly ambiguous words, such as single words and words that have multiple meanings. In other words, embodiments use unambiguous terms and their clustering first, to overcome the limitations presented with single words or words that have multiple meanings (outliers that either have no senses or too many senses) and therefore do not fall into a cluster group.

In one embodiment, a taxonomy generator 118 generates a taxonomy based on the clustering and a mining of taxonomies (mined taxonomies 102). As described herein, taxonomies, either public or private may be mined for their structure, such as terms, subject headings, etc. Of note, the system 100 directly mines taxonomies and/or accesses results of mined taxonomies 102. For each concept that it has deemed to be representative of the domain, the generated taxonomy is going describe the category that it belongs to, the likelihood that it belongs to that particular domain, the synonyms, and any other meaning based mark-up that is associated with that concept. So, once it is known which concepts are in the desired domain, and the senses associated therewith, then embodiments publish the taxonomy, the publishing of which is performed by methods well known in the art,

### Operation

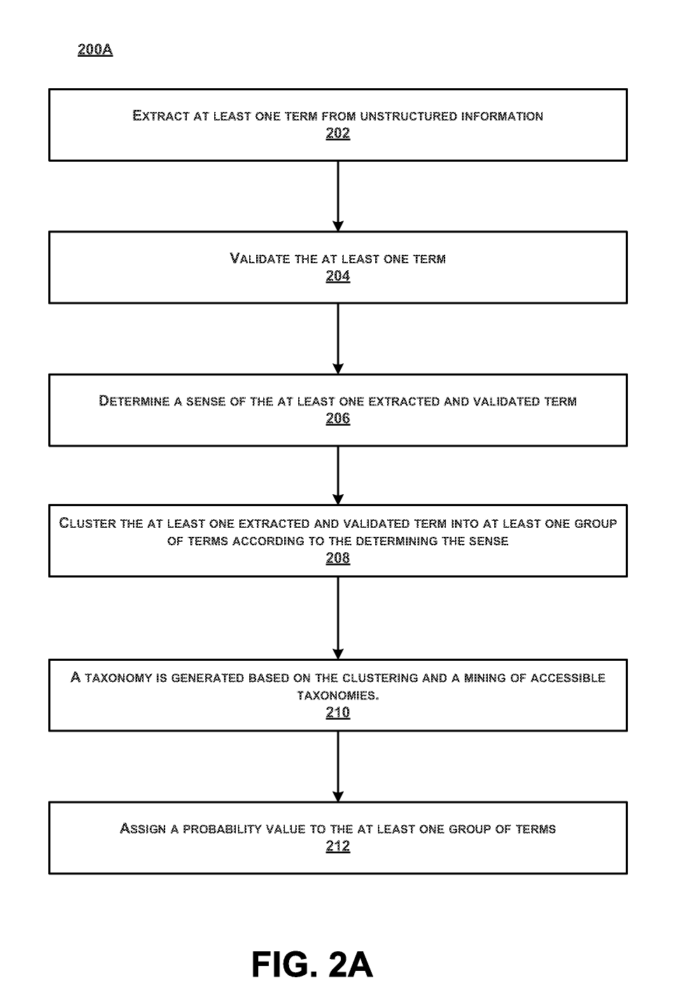

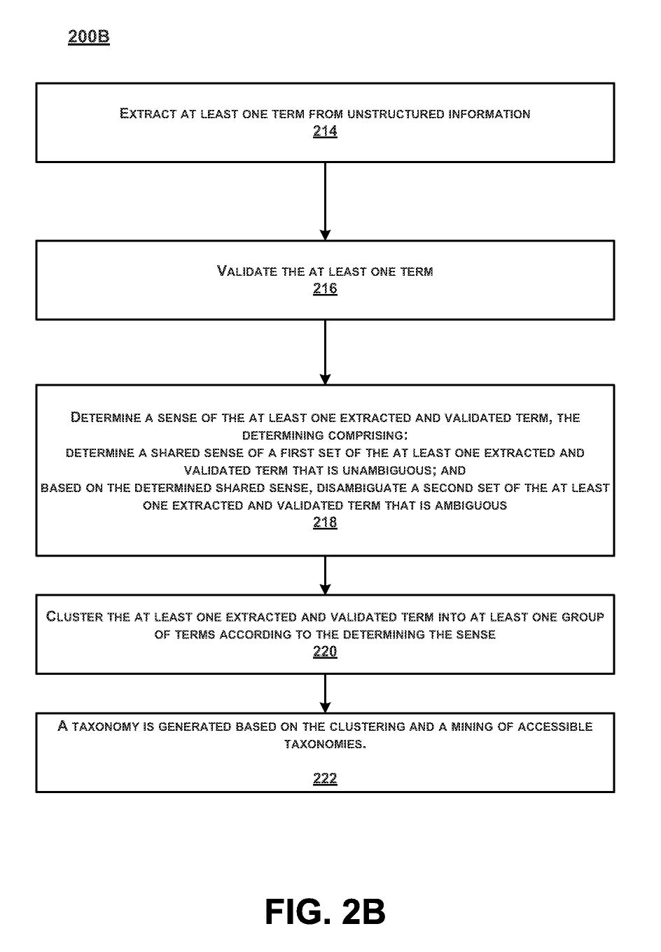

FIG. 2 is a flow diagram of a method 200A for generating a taxonomy from unstructured information 122. The method 200A is described below with reference to FIG. 1.

At 202, in one embodiment and as described herein, at least one term 124 is extracted from unstructured information 122. At 204, in one embodiment, and as described herein, the at least one term 124 is validated. In one embodiment, a value is assigned to the at least one extracted and validated term 108. The value represents a probability that the term is related to the user's intended search query.

In one embodiment, the validating of the at least one term 124 at 204 includes estimating a probability of the co-occurrence of the at least one extracted and validated term 108, based at least on a language model (the language model being described herein). For example, embodiments use a probability estimation of word co-occurrence, based on language models to try to validate the terms and their position within the document (it looks at terms that are next to each other and determines how likely these terms are to be next to each other.). Embodiments provide a probabilistic model of how likely these words are to co-occur. For example, embodiments determine if these parts of speech should be located right next to each other.

In one embodiment, the validating of the at least one term 124 at 204 includes estimating a probability that a first term of the at least one extracted term is related to a second term of the at least one extracted term and belongs to a domain. For example, embodiments determine how unlikely the terms are to be related to each other. For instance, consider the concept of conversion units. An embodiment will look at conversion end units and it discovers things like dimensions, fundamental units, and core units. An embodiment then looks at the broad area that is implied by such terms. An embodiment knows that the term has something to do with physics. An embodiment then estimates the probability that it belongs to the domain. It looks around in the document to see if there are other terms that belong to that domain, and based on this probability, an embodiment either signals validation or does not signal validation.

Those terms that fail validation are published as non-related (nonvalidated) terms. They can still be manually placed by the user. And as compared to current systems, with a 100% extraction rate, embodiments of the present technology achieve a phenomenally higher validation rate as compared to the state of the art, which sits at around 10 to 15%.

At 206, in one embodiment and as described herein, a sense of at least one extracted and validated term 108 is determined. In one embodiment and as described herein, a shared sense of a first set of the at least one extracted and validated term 108 that is unambiguous is shared. Further, in one embodiment and as described herein, based on the determined shared sense, a second set of the at least one extracted and validated term 108 that is ambiguous is disambiguated.

At 208, in one embodiment and as described herein, the at least one extracted and validated term 108 is clustered into at least one group 112 of terms according to the determined sense. In one embodiment and as described herein, the terms with shared hypernyms are grouped together. In another embodiment, terms that are synonymous are grouped in synonym rings. In one embodiment, terms with shared senses are grouped together.

At 210, in one embodiment and as described herein, a taxonomy is generated based on the clustering and a mining of taxonomies. Of note, the taxonomies (102) that are mined are accessible to the system 100, directly and/or indirectly. In one embodiment, the taxonomy is generated in a human readable format. Therefore, a user who is unhappy with the search results or wishing to manually modify the search, may do so. In one embodiment the user is presented with by an original representation of the taxonomy. The taxonomy will look like a tree or a part of the tree or a part of some hierarchy, parts of which (categories within) will be able to be deleted. Further, links between categories may be deleted. When a category is deleted inside of a taxonomy, it will influence other categories inside of it and other terms. In one embodiment, the user is presented with some instructions and options regarding deletion. For example, if some high level category is deleted, then all the categories below it will also be deleted. In one embodiment, the user is informed of this possibility. In another embodiment, if the user is not sure that he/she wishes to delete a category, the user may just mark it as “probably” or some equivalent indication, at which point this indication tells the system 100 that the user does not mind if the category is deleted later. Thus, embodiments assist the user when the user is not satisfied with the automatic results and wish to repair some link or delete some terms of some links. Thus, embodiments of the present technology also provide a graphical user interface (GUI) for interactive extraction of ontologies from documents. Further, embodiments provide a workflow design for assisting users in extracting ontologies from the documents. In another embodiment, the taxonomy is generated in a computer readable format.

At 212, in one embodiment and as described herein, a probability value is assigned to the at least one group 112 of terms.

Thus, embodiments of the present technology make automatic sense of unstructured information 122 by detecting the subject matter of such unstructured information 122 (e-mails, documents and Web pages, etc.) and organizing the subject matter into various human-readable and machine-friendly computer output formats.

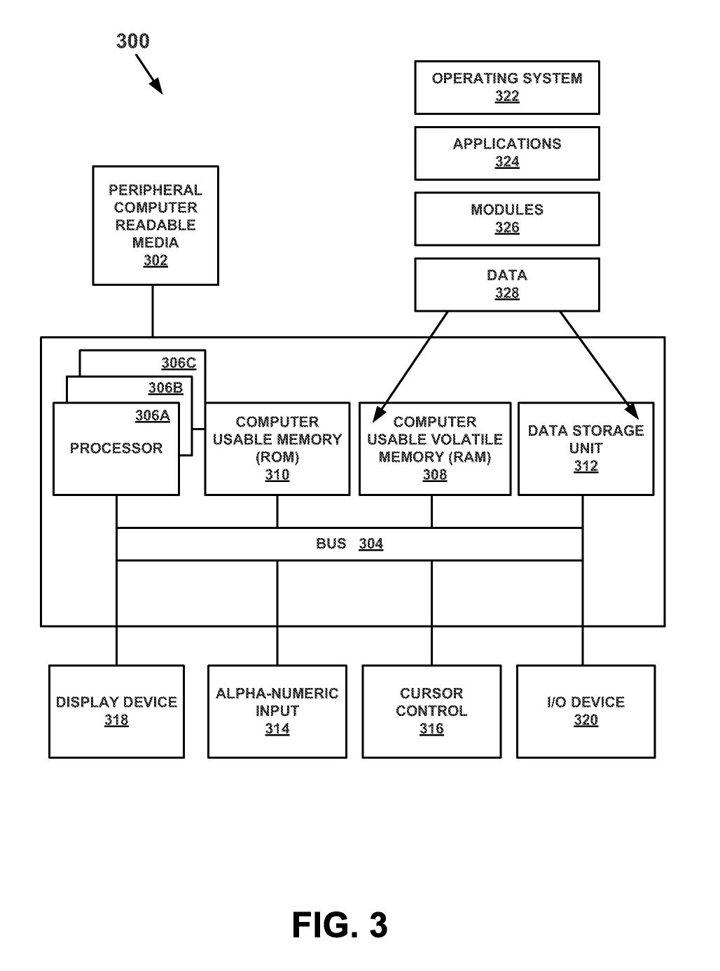

FIG. 2B is a flow diagram of a method 200B. In one embodiment, method 200B is embodied in instructions, stored on a non-transitory computer-readable storage medium, which when executed by a computer system (see 300 of FIG. 3), cause the computer system to perform the method 200B for generating a taxonomy from unstructured information 122. The method 200B is described below with reference to FIG. 1.

At 214, in one embodiment and as describe herein, at least one term 124 is extracted from unstructured information 122. At 216, in one embodiment and as describe herein, the at least one term 124 is validated. At 218, in one embodiment and as described herein, determining a sense of at least one extracted and validated term 108, said determining comprising: a shared sense of a first set of the at least one extracted and validated term 108 that is unambiguous is determined: and based on a determined shared sense, a second set of the at least one extracted and validated term 108 that is ambiguous is disambiguated.

At 220, in one embodiment and as described herein, the at least one extracted and validated term 108 is clustered into at least one group 112 of terms according to the determined sense. At 222, in one embodiment and as described herein, a taxonomy is generated based on the clustering and a mining of taxonomies.

### Example Computer System Environment

With reference now to FIG. 3, portions of the technology for generating a taxonomy from unstructured information are composed of computer-readable and computer-executable instructions that reside, for example, in computer-readable storage media of a computer system. That is, FIG. 3 illustrates one example of a type of computer that can be used to implement embodiments, which are discussed below, of the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand alone computer systems, and the like. As shown in FIG. 3, computer system 300 of FIG. 3 is well adapted to having peripheral computer readable media 302 such as, for example, a floppy disk, a compact disc, and the like coupled thereto.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. System 300 also includes data storage features such as a computer usable volatile memory 308, e.g. random access memory (RAM), coupled to bus 304 for storing information and instructions for processors 306A, 306B, and 306C.

System 300 also includes computer usable non-volatile memory 310, e.g. read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. System 300 also includes an optional alphanumeric input device 314 including alphanumeric and function keys coupled to bus 304 for communicating information and command selections to processor 306A or processors 306A, 306B, and 306C. System 300 also includes an optional cursor control device 316 coupled to bus 304 for communicating user input information and command selections to processor 306A or processors 306A, 306B, and 306C. System 300 of the present embodiment also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alphanumeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities. For example, in one embodiment, I/O device 320 is a modern for enabling wired or wireless communications between system 300 and an external network such as, but not limited to, the Internet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300. For example, a method for identifying a device associated with a transfer of content may be applied to operating system 322, applications 324, modules 326, and/or data 328.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network, in a distributed computing environment, program modules may be located in both local and remote computer-storage media including memory-storage devices,

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein, Rather, the scope and spirit of present invention is embodied by the appended claims.

What we claim is:

1. A method [200A] for generating a taxonomy from unstructured information, said method comprising:
extracting [202] at least one term from unstructured information [122];
validating [204] said at least one term [124];
determining [206] a sense of at least one extracted and validated term [108];
clustering [208] said at least one extracted and validated term [108] into at least one group [112] of terms according to said determined sense; and
generating [210] a taxonomy [120] based on said clustering and a minin of accessible taxonomies.

2. The method [200A] of claim 1, further comprising:
assigning [212] a probability value to said at least one group [112] of terms.

3. The method [200A] of claim 1, wherein said determining [206] a sense of at least one extracted and validated term comprises:
determining a shared sense of a first set of said at least one extracted and validated term[108] that is unambiguous.

4. The method [200A] of claim 3, further comprising:
based on a determined shared sense, disambiguating a second set of said at least one extracted and validated term [108] that is ambiguous.

5. The method [200A] of claim 1, wherein said validating [204] at least one term [124] comprises:
estimating a probability of a co-occurrence of said at least one extracted term, based on at least one language model.

6. The method [200A] of claim 1, wherein said validating [204] at least one term [124] comprises:
estimating a probability that a first term of said at least one extracted term is related to a second term of said at least one extracted term and belongs to a domain.

7. The method [200A] of claim 1, wherein said generating [210] a taxonomy based on said clustering and a mining of taxonomies comprises:
generating said taxonomy [120] that is in a human readable format.

8. The method [200A] of claim 1, wherein said generating [210] a taxonomy [120] based on said clustering and a mining of taxonomies comprises:
generating said taxonomy [120] that is in a computer readable format.

9. The method [200A] of claim 1, wherein said clustering [208] said at least one extracted and validated term [108] into at least one group [112] of terms according to said determining [206] said sense comprises:
grouping together terms with shared hypernyms.

10. The method [200A] of claim 1, wherein said clustering [208] said at least one extracted and validated term [108] into at least one group [112] of terms according to said determining [206] said sense comprises:
grouping synonymous terms into synonym rings.

11. The method [200A] of claim 1, wherein said clustering [208] said at least one extracted and validated term [108] into at least one group [112] of terms according to said determining [206] said sense comprises:
grouping together terms with shared senses.

12. A system [100] comprising:
a term extractor [104] configured for extracting at least one term [124] from unstructured information [122];
a term validater [106] configured for validating said at least one term [124];
a sense determiner [126] configured for determining a sense of at least one extracted and validated term [108];
a term clusterer [110] configured for clustering said at least one extracted and validated term [108] into at least one group [112] of terms according to a determined sense; and
a taxonomy generator [118] configured for generating a taxonomy [120] based on said clustering and a mining of taxonomies [102].

13. The system [100] of claim 12, wherein said sense determiner [126] comprising:
a shared sense determiner [114] configured for determining a shared sense of a first set of said at least one extracted and validated term [108] that is unambiguous; and
a term disambiguater [116] configured for, based on a determined shared sense, disambiguating a second set of said at least one extracted and validated term [108] that is ambiguous.

14. The system [100] of claim 12, wherein said unstructured formation [122] is a document comprising text.

15. A non-transitory computer-readable storage medium comprising instructions stored thereon which, when executed by a computer system, cause said computer system to perform a method [200B] for generating a taxonomy from unstructured information [122], said method comprising:
extracting [214] at least one term [124] from unstructured information [122];
validating [216] said at least one term [124];
determining [218] a sense of at least one extracted and validated term [108], said determining comprising:
determining a shared sense of a first set of said at least one extracted and validated term [108] that is unambiguous; and
based on a determined shared sense, disambiguating a second set of said at least one extracted and validated term [108] that is ambiguous;
clustering [220] said at least one extracted and validated term [108] into at least one group of terms according to said determined sense; and
generating [222] a taxonomy [120] based on said clustering and a mining of taxonomies.
